(19) United States
(12) Patent Application Publication
(10) Pub. No.: US 2022/0307227 A1
(43) Pub. Date: Sep. 29, 2022

(54) VISUAL INDICATION SYSTEM FOR POWER MACHINES

(71) Applicant: Clark Equipment Company, West Fargo, ND (US)

(72) Inventors: John Pfaff, Bismarck, ND (US); Matthew Sagaser, Bismarck, ND (US)

(21) Appl. No.: 17/706,074

(22) Filed: Mar. 28, 2022

Related U.S. Application Data
(60) Provisional application No. 63/166,332, filed on Mar. 26, 2021.

(51) Int. Cl. E02F 9/20; E02F 9/08; B62D 33/06; G07C 5/08; H05B 47/105

(52) U.S. Cl. CPC E02F 9/2095; E02F 9/0858; B62D 33/06; G07C 5/0808; H05B 47/105

(57) ABSTRACT

A power machine can include a visual indication system configured to provide visual indications in response to one or more detected operating conditions. In some cases, the visual indication system can be configured to emit light of different color, brightness, or patterns to indicate different operating conditions.

### CROSS-REFERENCE TO RELATED APPLICATION

This application claims priority to U.S. Provisional Patent Application No. 63/166,332 filed Mar. 26, 2021, the entirety of which is incorporated herein by reference.

### BACKGROUND

This disclosure is directed toward power machines. More particularly, this disclosure is directed to visual indication systems or illumination devices for power machines. Power machines, for the purposes of this disclosure, include any type of machine that generates power to accomplish a particular task or a variety of tasks. One type of power machine is a work vehicle. Work vehicles are generally self-propelled vehicles that have a work device, such as a lift arm (although some work vehicles can have other work devices) that can be manipulated to perform a work function. Work vehicles include loaders, excavators, utility vehicles, tractors, and trenchers, to name a few examples.

The discussion above is merely provided for general background information and is not intended to be used as an aid in determining the scope of the claimed subject matter.

### SUMMARY

Some embodiments of the present disclosure provide a visual indication system for a power machine that can provide visual indications to alert observers of particular operating conditions for the power machine. For example, by controlling aspects of illumination (e.g., color, intensity, or pattern) for one or more light sub-assemblies (e.g., integrated external light sub-assemblies), information regarding different internal or external operating conditions for a power machine can be conveyed to an operator of the power machine or to an observer within visual range of the power machine (e.g., to convey information regarding detected obstacles, power source status, control mode, etc.).

Some embodiments provide a power machine that includes a main frame that supports an operator station, a traction system coupled to the main frame, a work element operably coupled to the main frame, an electronic control module, and a visual indication system that is configured to emit a plurality of visual indications. The electronic control module is configured to detect an operating condition for the power machine, select one or more visual indications of the plurality of visual indications based on the detected operating condition for the power machine, and electronically control the visual indication system to emit the selected one or more visual indications externally to the operator station.

In some embodiments, a visual indication system includes a plurality of light sub-assemblies, including a first light sub-assembly configured to project illumination to a first side of the main frame, and a second light sub-assembly configured to project illumination to a second side of the main frame. In some embodiments, a plurality of light sub-assemblies includes a third light sub-assembly configured to project illumination to a third side of the main frame and a fourth light sub-assembly configured to project illumination to a fourth side of the main frame.

In some embodiments, a visual indication system is arranged to project selected one or more visual indications primarily forward of and laterally away from the operator station of the power machine.

In some embodiments, one or more light sub-assemblies are fixed-direction light sub-assemblies.

In some embodiments, the operator station includes a cab structure that defines a structural envelope of (e.g., surrounds) the operator station and the first and second light sub-assemblies are integrated into the cab structure to project light away from the operator station.

In some embodiments, a first light sub-assembly is a front light sub-assembly integrated onto one or more of the main frame or a frame of the operator station and oriented to project visual indications forward of the power machine. In some embodiments, a second light sub-assembly is a right side light sub-assembly integrated onto one or more of the main frame or a frame of the operator station and oriented to project visual indications to the right side of the power machine. In some embodiments, a third light sub-assembly is a left side light sub-assembly integrated onto one or more of the main frame or a frame of the operator station and oriented to project visual indications to the left side of the power machine.

In some embodiments, a frame of an operator station defines view areas for an operator of the power machine within the operator station, and at least one light sub-assembly is integrated onto the frame of the operator station to project the plurality of visual indications from above the view areas defined by the frame of the operator station.

In some embodiments, a power machine can further include an illumination system including a set of one or more headlights configured to illuminate terrain ahead of the main frame for driving operations, and a set of one or more lights configured to illuminate behind the main frame.

In different embodiments, illumination systems can be controllable to emit different visual indications. In some embodiments, a plurality of visual indications includes a first visual indication includes projected light having a first light intensity and a second visual indication includes projected light having a second light intensity different from the first light intensity. In some embodiments, a first visual indication includes projected light having a first pattern and a second visual indication includes projected light having a second pattern different from the first pattern. In some embodiments, a first visual indication includes projected light having a first color and a second visual indication includes projected light having a second color different from the first color.

In some embodiments, a sensor module is configured to detect one or more external environmental conditions and an electronic control module is configured to detect an operating condition based on detecting the one or more external environmental conditions. In different embodiments, one or more visual indications are selected based on different detected external environmental conditions, including: environmental temperature, environmental wetness, elevation, a slope of surrounding terrain, a presence of an obstruction detected by the sensor module, etc.

In some embodiments, a sensor module is configured to detect one or more internal operating conditions for the power machine and an electronic control module is configured to detect the operating condition for the power machine based on the detected one or more internal operating conditions. In different embodiments, one or more visual indications are selected based on different detected internal operating conditions, including a work element condition, a power machine speed (e.g., an internal combustion engine speed or other power source speed), an internal temperature, a battery capacity condition, or an engine power condition, etc.

In some embodiments, one or more visual indications are selected based on the operating condition including a powered and operable operating condition of the power machine. In some embodiments, one or more visual indications are selected based on the operating condition including a fault condition for one or more of a temperature sensor, a pressure sensor, or a diagnostics module. In some embodiments, one or more visual indications are selected based on the operating condition including a status of a communication link between the power machine and a remote control system.

Some embodiments provide an illumination assembly for a power machine. A sensor module is configured to detect one or more operating conditions for the power machine. A communications module is configured for wireless communication with systems external to the power machine. One or more light sub-assemblies are arranged exterior to an operator station of the power machine and configured to collectively emit a plurality of different visual indications. An electronic control module is configured to: detect at least one operating condition for the power machine based on one or more of receiving signals from the sensor module corresponding to sensor detection of the at least one operating condition, or determining a state of the communications module; and in response to detecting the at least one operating condition, control the one or more light sub-assemblies to emit a select one or more visual indications of the plurality of different visual indications to externally indicate the at least one operating condition for the power machine.

In some embodiments, a first light sub-assembly of the one or more light sub-assemblies is positioned on a front side of the power machine, and a second light sub-assembly of the one or more light sub-assemblies is positioned on a first lateral side of a power machine.

In some embodiments, first and second light sub-assemblies are fixed-direction light sub-assemblies integrated into a cab structure of a power machine.

In some embodiments, an electronic control module is configured to control the one or more light sub-assemblies to selectively indicate two or more of: a presence of an external object relative to the power machine; a powered and operable state of the power machine; or a control-communication status for the power machine.

Some embodiments provide a method of indicating a plurality of operating conditions of a power machine. An electronic control module receives signals from one or more of a sensor module or a communications module configured for wireless communication with systems external to the power machine, the signals corresponding to one or more operating conditions included in the plurality of operating conditions for the power machine. In response to receiving the signals, with the electronic control module: selects one or more visual indications from a plurality of visual indications that one or more light sub-assemblies of an illumination assembly of the power machine are configured to emit, the one or more visual indications corresponding to at least one of the one or more operating conditions; and controls the illumination assembly to cause one or more light sub-assemblies of the illumination assembly to emit the selected one or more visual indications to indicate the at least one operating condition by illuminating exterior surroundings of the power machine. In some embodiments, the plurality of visual indications include visual indications of one or more of different light intensities, different patterns, or different light colors.

Some embodiments provide a power machine. A main frame supports an operator station, a traction system is coupled to the main frame, a work element is operably coupled to the main frame, and a visual indication system is configured to emit a visual indication to indicate an operating conditions for the power machine, the visual indication system including one or more light sub-assemblies that are integrated onto one or more of the main frame or a frame of the operator station. In some embodiments, the visual indication system is configured to emit a plurality of visual indications to indicate one or more operating conditions for the power machine.

This Summary and the Abstract are provided to introduce a selection of concepts in a simplified form that are further described below in the Detailed Description. This Summary is not intended to identify key features or essential features of the claimed subject matter, nor are they intended to be used as an aid in determining the scope of the claimed subject matter.

### DRAWINGS

FIG. 1 is a block diagram illustrating functional systems of a representative power machine on which embodiments of the present disclosure can be advantageously practiced.

FIGS. 2-3 illustrate perspective views of a representative power machine in the form of a skid-steer loader of the type on which the disclosed embodiments can be practiced.

FIG. 4 is a block diagram illustrating components of a power system of a loader such as the loader illustrated in FIGS. 2-3.

FIG. 5 is a schematic view of a power machine according to an embodiment of the disclosure.

FIG. 6 is a front isometric view of a power machine according to an embodiment of the disclosure.

FIG. 7A is a front isometric partial view of the power machine of FIG. 6.

FIG. 7B is a rear elevation view of the power machine of FIG. 6.

FIG. 8 is a front elevation partial view of the power machine of FIG. 6.

FIG. 9 is a schematic view illustrating certain components of the power machine of FIG. 6.

FIG. 10 is a schematic representation of a method for visual indications for a power machine according to an embodiment of the disclosure.

FIG. 11 is another schematic representation of a method for visual indications for a power machine according to an embodiment of the disclosure.

### DETAILED DESCRIPTION

The concepts disclosed in this discussion are described and illustrated by referring to exemplary embodiments. These concepts, however, are not limited in their application to the details of construction and the arrangement of components in the illustrative embodiments and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

As used herein in the context of a power machine, unless otherwise defined or limited, the term “lateral” refers to a direction that extends at least partly to a left or a right side of a front-to-back reference line defined by the power machine. Accordingly, for example, a lateral side wall of a cab of a power machine can be a left side wall or a right side wall of the cab, relative to a frame of reference of an operator who is within the cab or is otherwise oriented to operatively engage with controls of an operator station of the cab. Similarly, a “centerline” of a power machine refers to a reference line that extends in a front-to-back direction of a power machine, approximately half-way between opposing lateral sides of an outer spatial envelope of the power machine. Also as used herein, the terms “about” and “approximately” mean plus or minus 5% of the number that each term precedes, unless otherwise specified.

While the power machines disclosed herein may be embodied in many different forms, several specific embodiments are discussed herein with the understanding that the embodiments described in the present invention are to be considered only exemplifications of the principles described herein, and the invention is not intended to be limited to the embodiments illustrated.

Some discussion below generally relates to illumination assemblies for power machines, which can be used to provide visual indication to an operator or other observers. For example, in some instances, it may be useful to visually indicate particular operating conditions for a power machine to an operator of the power machine or to observers that may be near the power machine. In some instances, operating conditions may relate to internal states of a power machine, including operating parameters of an engine or other power system, orientation of the power machine, operational states of implements or other work elements, etc. In some instances, operating conditions may relate to external conditions, including environmental conditions, presence (or absence) of objects or individuals in a particular area.

In some embodiments, to provide indications of operating conditions, illumination assemblies can be configured to primarily illuminate certain regions or directions (i.e., to illuminate certain regions or directions with a luminous intensity that is a more than 60% larger than luminous intensity in other regions or directions illuminated by the relevant illumination assembly or sub-assembly). For example, a power machine according to some embodiments can include a cab structure supported on a main frame, with front, right side, and left side light sub-assemblies integrated into the cab structure (e.g., nested below a top cover panel of the cab structure) and oriented to primarily illuminate a region that is forward of and laterally to the sides of an operator station (e.g., over a 180-degree span that is symmetrical about the forward direction).

In some embodiments, indicators of any variety of operating conditions can be detected (e.g., by dedicated or general purpose sensors) and the indicators can be communicated to a controller (e.g., a general or special purpose computer). The controller can then control one or more illumination assemblies to provide a visual indicator of the relevant operating condition(s), as may be visible to an operator or another observer near the power machine. For example, a power machine may include one or more sensors that are configured to detect one or more operating conditions of one or more components of the power machine (i.e., internal operating conditions) or of remote systems or the area surrounding the power machine (i.e., external operating conditions). A controller can automatically cause one or more light sub-assemblies to project light with a particular color, intensity, pattern (e.g., spatial pattern, or time sequence of light pulses), or other characteristic, as selected based on the detected operating condition(s), to provide a visual indicator of the detected operating condition(s).

In some embodiments, operating conditions can be detected based on detected parameters that satisfy particular criteria (e.g., detected pressure, temperature, battery charge, engine speed, etc. exceeding or not exceeding a particular threshold). In some embodiments, detected operating conditions that can be indicated using controlled illumination can include temperature or pressure of power machine components or systems (e.g., hydraulic fluid), power system parameters (e.g., battery charge, fuel tank level, etc.), status information for communication or other control systems (e.g., a status of a remote-control communications link), a operational state of the power machine (e.g., powered and enabled for operation (“operable”), operating under remote control, operating in power-saving/-boosted mode), or various other parameters relating to any number of fault or other conditions (e.g., power machine ground speed or power consumption rate).

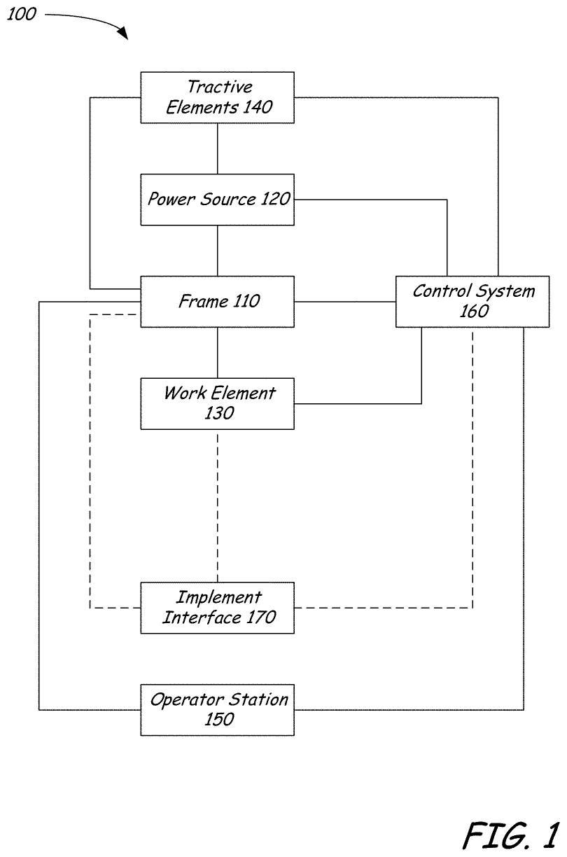

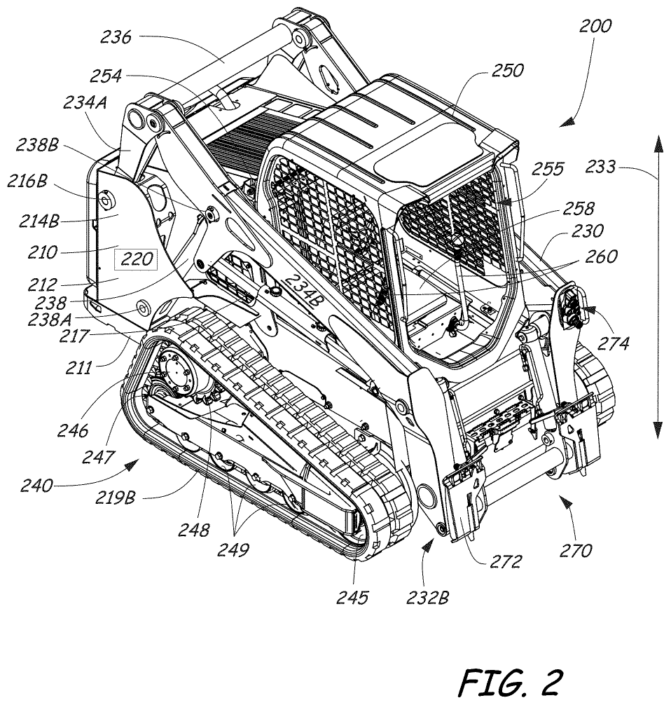

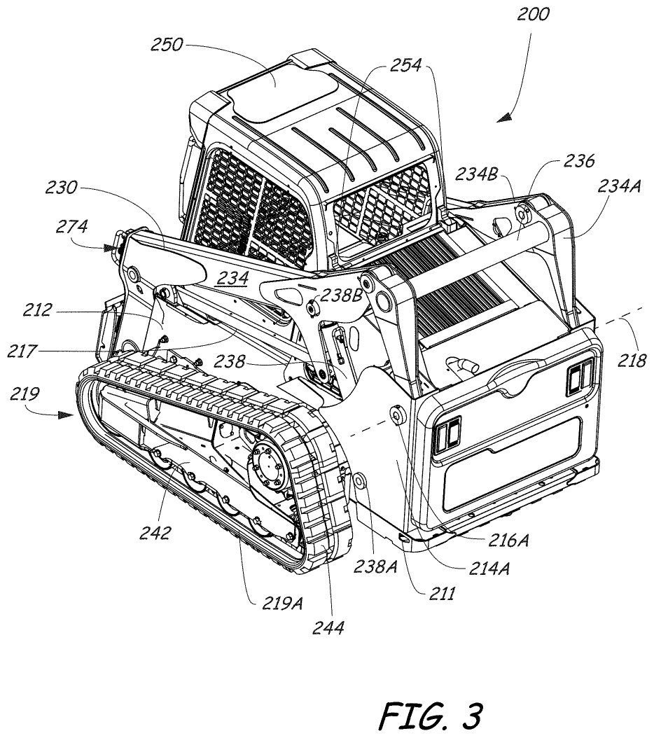

These concepts can be practiced on various power machines, as will be described below. A representative power machine on which the embodiments can be practiced is illustrated in diagram form in FIG. 1 and one example of such a power machine is illustrated in FIGS. 2-3 and described below before any embodiments are disclosed. For the sake of brevity, only one power machine is illustrated and discussed as being a representative power machine. However, as mentioned above, the embodiments below can be practiced on any of a number of power machines, including power machines of different types from the representative power machine shown in FIGS. 2-3. Power machines, for the purposes of this discussion, include a frame, at least one work element, and a power source that can provide power to the work element to accomplish a work task. One type of power machine is a self-propelled work vehicle. Self-propelled work vehicles are a class of power machines that include a frame, work element, and a power source that can provide power to the work element. At least one of the work elements is a motive system for moving the power machine under power.

Further, power machines on which embodiments of the present disclosure can be practiced may be hydraulically or electrically powered. For example, as illustrated as one example of a power machine in FIGS. 2-3, embodiments of the present disclosure can be employed on conventional machines having hydraulic actuators. Alternatively, embodiments of the present disclosure may also be incorporated into electric power machines that include electric actuators or electric motors.

FIG. 1 is a block diagram that illustrates the basic systems of a power machine 100, which can be any of a number of different types of power machines upon which the embodiments discussed below can be advantageously incorporated. The block diagram of FIG. 1 identifies various systems on power machine 100 and the relationship between various components and systems. As mentioned above, at the most basic level, power machines for the purposes of this discussion include a frame, a power source, and a work element. The power machine 100 has a frame 110, a power source 120, and a work element 130. Because power machine 100 shown in FIG. 1 is a self-propelled work vehicle, it also has tractive elements 140, which are themselves work elements provided to move the power machine over a support surface, and an operator station 150 that provides an operating position for controlling the work elements of the power machine. A control system 160 is provided to interact with the other systems to perform various work tasks at least in part in response to control signals provided by an operator.

Certain work vehicles have work elements that can perform a dedicated task. For example, some work vehicles have a lift arm to which an implement such as a bucket is attached such as by a pinning arrangement. The work element, i.e., the lift arm, can be manipulated to position the implement to perform the task. In some instances, the implement can be positioned relative to the work element, such as by rotating a bucket relative to a lift arm, to further position the implement. Under normal operation of such a work vehicle, the bucket is intended to be attached and under use. Such work vehicles may be able to accept other implements by disassembling the implement/work element combination and reassembling another implement in place of the original bucket. Other work vehicles, however, are intended to be used with a wide variety of implements and have an implement interface such as implement interface 170 shown in FIG. 1. At its most basic, implement interface 170 is a connection mechanism between the frame 110 or a work element 130 and an implement, which can be as simple as a connection point for attaching an implement directly to the frame 110 or a work element 130 or more complex, as discussed below.

On some power machines, implement interface 170 can include an implement carrier, which is a physical structure movably attached to a work element. The implement carrier has engagement features and locking features to accept and secure any of a number of different implements to the work element. One characteristic of such an implement carrier is that once an implement is attached to it, it is fixed to the implement (i.e. not movable with respect to the implement) and when the implement carrier is moved with respect to the work element, the implement moves with the implement carrier. The term implement carrier as used herein is not merely a pivotal connection point, but rather a dedicated device specifically intended to accept and be secured to various different implements. The implement carrier itself is mountable to a work element 130 such as a lift arm or the frame 110. Implement interface 170 can also include one or more power sources for providing power to one or more work elements on an implement. Some power machines can have a plurality of work element with implement interfaces, each of which may, but need not, have an implement carrier for receiving implements. Some other power machines can have a work element with a plurality of implement interfaces so that a single work element can accept a plurality of implements simultaneously. Each of these implement interfaces can, but need not, have an implement carrier.

Frame 110 includes a physical structure that can support various other components that are attached thereto or positioned thereon. The frame 110 can include any number of individual components. Some power machines have frames that are rigid. That is, no part of the frame is movable with respect to another part of the frame. Other power machines have at least one portion can move with respect to another portion of the frame. For example, excavators can have an upper frame portion that rotates with respect to a lower frame portion. Other work vehicles have articulated frames such that one portion of the frame pivots with respect to another portion for accomplishing steering functions.

Frame 110 supports the power source 120, which is configured to provide power to one or more work elements 130 including the one or more tractive elements 140, as well as, in some instances, providing power for use by an attached implement via implement interface 170. Power from the power source 120 can be provided directly to any of the work elements 130, tractive elements 140, and implement interfaces 170. Alternatively, power from the power source 120 can be provided to a control system 160, which in turn selectively provides power to the elements that capable of using it to perform a work function. Power sources for power machines typically include an engine such as an internal combustion engine and a power conversion system such as a mechanical transmission or a hydraulic system that is configured to convert the output from an engine into a form of power that is usable by a work element. Other types of power sources can be incorporated into power machines, including electrical sources or a combination of power sources, known generally as hybrid power sources.

FIG. 1 shows a single work element designated as work element 130, but various power machines can have any number of work elements. Work elements are typically attached to the frame of the power machine and movable with respect to the frame when performing a work task. In some embodiments, as also discussed above, work elements can include lift arm assemblies. In some embodiments, work elements can include mower decks or other similar equipment. In addition, tractive elements 140 are a special case of work element in that their work function is generally to move the power machine 100 over a support surface. Tractive elements 140 are shown separate from the work element 130 because many power machines have additional work elements besides tractive elements, although that is not always the case. Power machines can have any number of tractive elements, some or all of which can receive power from the power source 120 to propel the power machine 100. Tractive elements can be, for example, wheels attached to an axle, track assemblies, and the like. Tractive elements can be mounted to the frame such that movement of the tractive element is limited to rotation about an axle (so that steering is accomplished by a skidding action) or, alternatively, pivotally mounted to the frame to accomplish steering by pivoting the tractive element with respect to the frame.

Power machine 100 includes an operator station 150 that includes an operating position from which an operator can control operation of the power machine. In some power machines, the operator station 150 is defined by an enclosed or partially enclosed cab. Some power machines on which the disclosed embodiments may be practiced may not have a cab or an operator compartment of the type described above. For example, a walk behind loader may not have a cab or an operator compartment, but rather an operating position that serves as an operator station from which the power machine is properly operated. More broadly, power machines other than work vehicles may have operator stations that are not necessarily similar to the operating positions and operator compartments referenced above. Further, some power machines such as power machine 100 and others, whether or not they have operator compartments or operator positions, may be capable of being operated remotely (i.e. from a remotely located operator station) instead of or in addition to an operator station adjacent or on the power machine. This can include applications where at least some of the operator-controlled functions of the power machine can be operated from an operating position associated with an implement that is coupled to the power machine. Alternatively, with some power machines, a remote-control device can be provided (i.e. remote from both of the power machine and any implement to which is it coupled) that is capable of controlling at least some of the operator controlled functions on the power machine.

FIGS. 2-3 illustrate a loader 200, which is one particular example of a power machine of the type illustrated in FIG. 1 where the embodiments discussed below can be advantageously employed. Loader 200 is a track loader and more particularly, a compact tracked loader. A track loader is a loader that has endless tracks as tractive elements (as opposed to wheels). Track loader 200 is one particular example of the power machine 100 illustrated broadly in FIG. 1 and discussed above. To that end, features of loader 200 described below include reference numbers that are generally similar to those used in FIG. 1. For example, loader 200 is described as having a frame 210, just as power machine 100 has a frame 110. Track loader 200 is described herein to provide a reference for understanding one environment on which the embodiments described below related to track assemblies and mounting elements for mounting the track assemblies to a power machine may be practiced. The loader 200 should not be considered limiting especially as to the description of features that loader 200 may have described herein that are not essential to the disclosed embodiments and thus may or may not be included in power machines other than loader 200 upon which the embodiments disclosed below may be advantageously practiced. Unless specifically noted otherwise, embodiments disclosed below can be practiced on a variety of power machines, with the track loader 200 being only one of those power machines. For example, some or all of the concepts discussed below can be practiced on many other types of work vehicles such as various other loaders, excavators, trenchers, and dozers, to name but a few examples.

Loader 200 includes frame 210 that supports a power system 220, the power system being capable of generating or otherwise providing power for operating various functions on the power machine. The power system 220 is shown in block diagram form, but is located within the frame 210. Frame 210 also supports a work element in the form of a lift arm structure 230 that is powered by the power system 220 and that can perform various work tasks. As loader 200 is a work vehicle, frame 210 also supports a traction system 240, which is also powered by power system 220 and can propel the power machine over a support surface. The lift arm structure 230 in turn supports an implement interface 270, which includes an implement carrier 272, which can receive and secure various implements to the loader 200 for performing various work tasks, and power couplers 274, to which an implement can be coupled for selectively providing power to an implement that might be connected to the loader. Power couplers 274 can provide sources of hydraulic or electric power or both. The loader 200 includes a cab 250 that defines an operator station 255 from which an operator can manipulate various control devices 260 to cause the power machine to perform various work functions. Cab 250 can be pivoted back about an axis that extends through mounts 254 to provide access to power system components as needed for maintenance and repair.

The operator station 255 includes an operator seat 258 and a plurality of operation input devices, including control levers 260 that an operator can manipulate to control various machine functions. Operator input devices can include buttons, switches, levers, sliders, pedals and the like that can be stand-alone devices such as hand operated levers or foot pedals or incorporated into hand grips or display panels, including programmable input devices. Actuation of operator input devices can generate signals in the form of electrical signals, hydraulic signals, or mechanical signals. Signals generated in response to operator input devices are provided to various components on the power machine for controlling various functions on the power machine. Among the functions that are controlled via operator input devices on power machine 100 include control of the tractive elements 219, the lift arm structure 230, the implement carrier 272, and providing signals to any implement that may be operably coupled to the implement.

Loaders can include human-machine interfaces including display devices that are provided in the cab 250 to give indications of information relatable to the operation of the power machines in a form that can be sensed by an operator, such as, for example audible or visual indications. Audible indications can be made in the form of buzzers, bells, and the like or via verbal communication. Visual indications can be made in the form of graphs, lights, icons, gauges, alphanumeric characters, and the like. Displays can be dedicated to providing dedicated indications, such as warning lights or gauges, or dynamic to provide programmable information, including programmable display devices such as monitors of various sizes and capabilities. Display devices can provide diagnostic information, troubleshooting information, instructional information, and various other types of information that assists an operator with operation of the power machine or an implement coupled to the power machine. Other information that may be useful for an operator can also be provided. Other power machines, such walk behind loaders may not have a cab nor an operator compartment, nor a seat. The operator position on such loaders is generally defined relative to a position where an operator is best suited to manipulate operator input devices.

Various power machines that can include or interact with the embodiments discussed below can have various different frame components that support various work elements. The elements of frame 210 discussed herein are provided for illustrative purposes and frame 210 is not the only type of frame that a power machine on which the embodiments can be practiced can employ. Frame 210 of loader 200 includes an undercarriage or lower portion 211 of the frame and a mainframe or upper portion 212 of the frame that is supported by the undercarriage. The mainframe 212 of loader 200, in some embodiments is attached to the undercarriage 211 such as with fasteners or by welding the undercarriage to the mainframe. Alternatively, the mainframe and undercarriage can be integrally formed. Mainframe 212 includes a pair of upright portions 214A and 214B located on either side and toward the rear of the mainframe that support lift arm assembly 230 and to which the lift arm assembly 230 is pivotally attached. The lift arm assembly 230 is illustratively pinned to each of the upright portions 214A and 214B. The combination of mounting features on the upright portions 214A and 214B and the lift arm assembly 230 and mounting hardware (including pins used to pin the lift arm assembly to the mainframe 212) are collectively referred to as joints 216A and 216B (one is located on each of the upright portions 214) for the purposes of this discussion. Joints 216A and 216B are aligned along an axis 218 so that the lift arm assembly is capable of pivoting, as discussed below, with respect to the frame 210 about axis 218. Other power machines may not include upright portions on either side of the frame, or may not have a lift arm assembly that is mountable to upright portions on either side and toward the rear of the frame. For example, some power machines may have a single arm, mounted to a single side of the power machine or to a front or rear end of the power machine. Other machines can have a plurality of work elements, including a plurality of lift arms, each of which is mounted to the machine in its own configuration. Frame 210 also supports a pair of tractive elements 242 on either side of the loader 200 (only one is shown in FIG. 2), which on the loader 200 are track assemblies.

The lift arm assembly 230 shown in FIGS. 2-3 is one example of many different types of lift arm assemblies that can be attached to a power machine such as loader 200 or other power machines on which embodiments of the present discussion can be practiced. The lift arm assembly 230 is what is known as a vertical lift arm, meaning that the lift arm assembly 230 is moveable (i.e. the lift arm assembly can be raised and lowered) under control of the loader 200 with respect to the frame 210 along a lift path 237 that forms a generally vertical path. Other lift arm assemblies can have different geometries and can be coupled to the frame of a loader in various ways to provide lift paths that differ from the radial path of lift arm assembly 230. For example, some lift paths on other loaders provide a radial lift path. Other lift arm assemblies can have an extendable or telescoping portion. Other power machines can have a plurality of lift arm assemblies attached to their frames, with each lift arm assembly being independent of the other(s). Unless specifically stated otherwise, none of the inventive concepts set forth in this discussion are limited by the type or number of lift arm assemblies that are coupled to a particular power machine.

The lift arm assembly 230 has a pair of lift arms 234 that are disposed on opposing sides of the frame 210. A first end of each of the lift arms 234 is pivotally coupled to the power machine at joints 216 and a second end 232B of each of the lift arms is positioned forward of the frame 210 when in a lowered position as shown in FIG. 2. Joints 216 are located toward a rear of the loader 200 so that the lift arms extend along the sides of the frame 210. The lift path 237 is defined by the path of travel of the second end 232B of the lift arms 234 as the lift arm assembly 230 is moved between a minimum and maximum height.

Each of the lift arms 234 has a first portion 234A of each lift arm 234 is pivotally coupled to the frame 210 at one of the joints 216 and the second portion 234B extends from its connection to the first portion 234A to the second end 232B of the lift arm assembly 230. The lift arms 234 are each coupled to a cross member 236 that is attached to the first portions 234A. Cross member 236 provides increased structural stability to the lift arm assembly 230. A pair of actuators 238, which on loader 200 are hydraulic cylinders configured to receive pressurized fluid from power system 220, are pivotally coupled to both the frame 210 and the lift arms 234 at pivotable joints 238A and 238B, respectively, on either side of the loader 200. The actuators 238 are sometimes referred to individually and collectively as lift cylinders. Actuation (i.e., extension and retraction) of the actuators 238 cause the lift arm assembly 230 to pivot about joints 216 and thereby be raised and lowered along a fixed path illustrated by arrow 233. Each of a pair of control links 217 are pivotally mounted to the frame 210 and one of the lift arms 232 on either side of the frame 210. The control links 217 help to define the fixed lift path of the lift arm assembly 230.

Some lift arms, most notably lift arms on excavators but also possible on loaders, may have portions that are controllable to pivot with respect to another segment instead of moving in concert (i.e. along a pre-determined path) as is the case in the lift arm assembly 230 shown in FIG. 2. Some power machines have lift arm assemblies with a single lift arm, such as is known in excavators or even some loaders and other power machines. Other power machines can have a plurality of lift arm assemblies, each being independent of the other(s).

An implement interface 270 is provided proximal to a second end 232B of the lift arm assembly 234. The implement interface 270 includes an implement carrier 272 that is capable of accepting and securing a variety of different implements to the lift arm 230. Such implements have a complementary machine interface that is configured to be engaged with the implement carrier 272. The implement carrier 272 is pivotally mounted at the second end 232B of the arm 234. Implement carrier actuators are operably coupled the lift arm assembly 230 and the implement carrier 272 and are operable to rotate the implement carrier with respect to the lift arm assembly. Implement carrier actuators 235 are illustratively hydraulic cylinders and often known as tilt cylinders.

By having an implement carrier capable of being attached to a plurality of different implements, changing from one implement to another can be accomplished with relative ease. For example, machines with implement carriers can provide an actuator between the implement carrier and the lift arm assembly, so that removing or attaching an implement does not involve removing or attaching an actuator from the implement or removing or attaching the implement from the lift arm assembly. The implement carrier 272 provides a mounting structure for easily attaching an implement to the lift arm (or other portion of a power machine) that a lift arm assembly without an implement carrier does not have.

Some power machines can have implements or implement like devices attached to it such as by being pinned to a lift arm with a tilt actuator also coupled directly to the implement or implement type structure. A common example of such an implement that is rotatably pinned to a lift arm is a bucket, with one or more tilt cylinders being attached to a bracket that is fixed directly onto the bucket such as by welding or with fasteners. Such a power machine does not have an implement carrier, but rather has a direct connection between a lift arm and an implement.

The implement interface 270 also includes an implement power source 274 available for connection to an implement on the lift arm assembly 230. The implement power source 274 includes pressurized hydraulic fluid port to which an implement can be removably coupled. The pressurized hydraulic fluid port selectively provides pressurized hydraulic fluid for powering one or more functions or actuators on an implement. The implement power source can also include an electrical power source for powering electrical actuators or an electronic controller on an implement. The implement power source 274 also exemplarily includes electrical conduits that are in communication with a data bus on the excavator 200 to allow communication between a controller on an implement and electronic devices on the loader 200.

The lower frame 211 supports and has attached to it the pair of tractive elements 242. Each of the tractive elements 242 has a track frame that is coupled to the lower frame 211. The track frame supports and is surrounded by an endless track 244, which rotates under power to propel the loader 200 over a support surface. Various elements are coupled to or otherwise supported by the track frame for engaging and supporting the endless track 244 and cause it to rotate about the track frame. For example, a sprocket 246 is supported by the track frame and engages the endless track 244 to cause the endless track to rotate about the track frame. An idler 245 is held against the track 244 by a tensioner (not shown) to maintain proper tension on the track. The track frame also supports a plurality of rollers 249, which engage the track and, through the track, the support surface to support and distribute the weight of the loader 200.

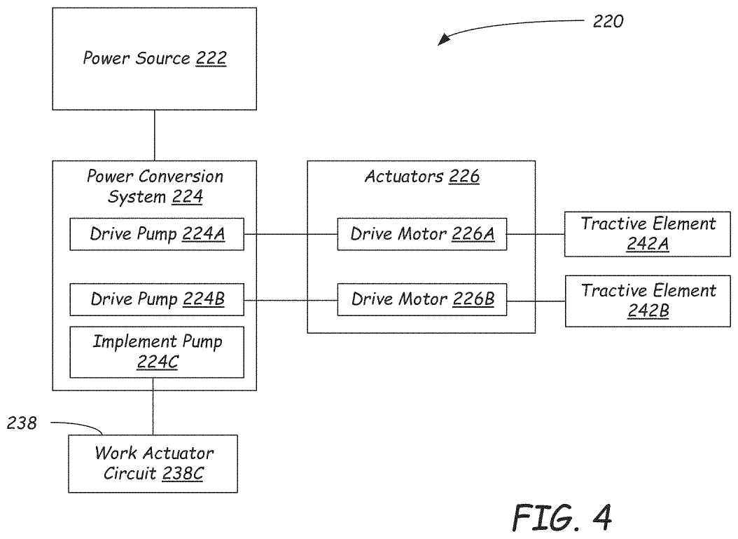

Frame 210 supports and generally encloses the power system 220 so that the various components of the power system 220 are not visible in FIGS. 2-3. FIG. 4 includes, among other things, a diagram of various components of the power system 220. Power system 220 includes one or more power sources 222 that are capable of generating or storing power for use on various machine functions. On power machine 200, the power system 220 includes an internal combustion engine. Other power machines can include electric generators, rechargeable batteries, various other power sources or any combination of power sources that can provide power for given power machine components. The power system 220 also includes a power conversion system 224, which is operably coupled to the power source 222. Power conversion system 224 is, in turn, coupled to one or more actuators 226, which can perform a function on the power machine. Power conversion systems in various power machines can include various components, including mechanical transmissions, hydraulic systems, and the like. The power conversion system 224 of power machine 200 includes a pair of hydrostatic drive pumps 224A and 224B, which are selectively controllable to provide a power signal to drive motors 226A and 226B. The drive motors 226A and 226B in turn are each operably coupled to axles, with drive motor 226A being coupled to axles 228A and 228B and drive motor 226B being coupled to tractive elements 224A, 224B, respectively. The drive pumps 224A and 224B can be mechanically, hydraulic, or electrically coupled to operator input devices to receive actuation signals for controlling the drive pumps.

The arrangement of drive pumps, motors, and tractive elements in power machine 200 is but one example of an arrangement of these components. As discussed above, power machine 200 is a tracked loader with a single tractive element on each side of the power machine, and with each of the tractive elements controlled via the output of a respective hydraulic pump that is coupled to the respective tractive element. Various other configurations and combinations of hydraulic drive pumps and motors can be employed as may be advantageous.

The power conversion system 224 of power machine 200 also includes a hydraulic implement pump 224C, which is also operably coupled to the power source 222. The hydraulic implement pump 224C is operably coupled to work actuator circuit 238C. Work actuator circuit 238C includes lift cylinders 238 and tilt cylinders as well as control logic to control actuation thereof. The control logic selectively allows, in response to operator inputs, for actuation of the lift cylinders or tilt cylinders. In some machines, the work actuator circuit also includes control logic to selectively provide a pressurized hydraulic fluid to an attached implement. The control logic of power machine 200 includes an open center, 3 spool valve in a series arrangement. The spools are arranged to give priority to the lift cylinders, then the tilt cylinders, and then pressurized fluid to an attached implement.

The description of power machine 100 and loader 200 above is provided for illustrative purposes, to provide illustrative environments on which the embodiments discussed below can be practiced. While the embodiments discussed can be practiced on a power machine such as is generally described by the power machine 100 shown in the block diagram of FIG. 1 and more particularly on a loader such as track loader 200, unless otherwise noted or recited, the concepts discussed below are not intended to be limited in their application to the environments specifically described above.

As mentioned above, power machines according to embodiments of the present disclosure are intended to provide effective and intuitive indication of the machine's operating conditions, or other environmental conditions, to an operator or bystanders. Therefore, power machines according to embodiments of the present disclosure may incorporate a visual indication system to provide visual feedback, e.g., via illumination, to an operator or bystanders, including to communicate different operating conditions of the power machines via differently projected illumination (e.g., illumination with different colors, patterns, intensities, etc. projected primarily externally to an operator station of the power machine).

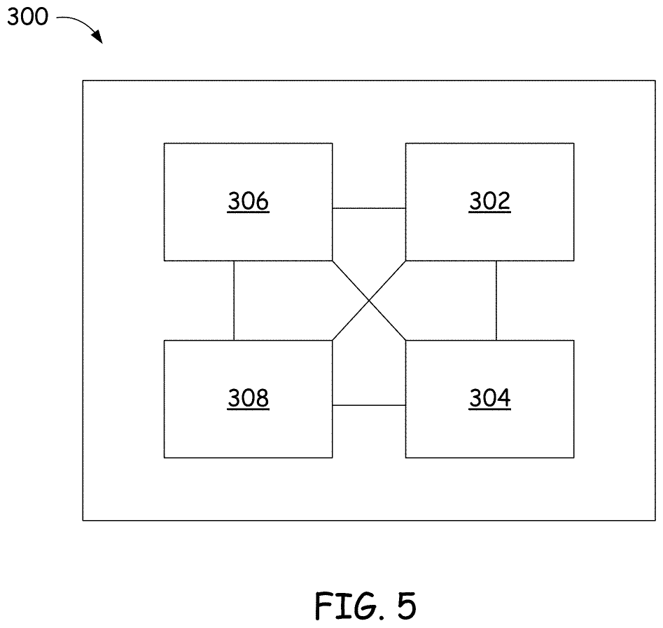

FIG. 5 illustrates an example schematic of a power machine 300 that includes a visual indication system 302 according to an embodiment of the disclosure. Generally, the visual indication system 302 is configured to provide visual indication of the machine's operating conditions to an operator or bystander. The power machine 300 includes a control module 304, which may be configured to provide power and control signals for executing or monitoring functions on the power machine 300 and can be implemented as a general or special purpose computer or using any variety of other generally known types of control devices. The control module 304 can be electrically connected to a power system 306 for powering components of the power machine 300 so that the control module 304 can selectively power components of the power machine 300 via the power system 306. For example, the control module 304 may be configured to selectively power or operatively control the visual indication system 302.

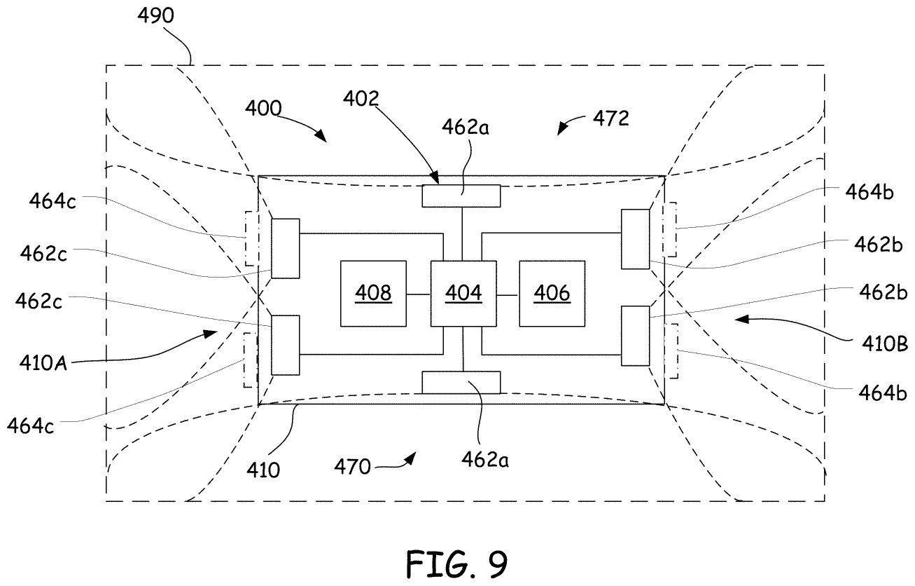

Although the control module 304 is illustrated as a separate component from the visual indication system 302, some embodiments of a visual indication system may include a dedicated controller that may or may not be in communication with a separate controller of the power machine. In this regard, for example, some embodiments of a visual indication system may be directly in communication with a power system, a sensor module, or other components of a power machine, including particular examples of these components as further discussed below. Likewise, although FIG. 5 shows various interconnections between the systems/modules 302-308, other configurations are possible. For example, one or more the modules may be a (larger) host module or a sub-module for one or more of the other modules. Further, some direct interconnections may not be implemented exactly as shown in FIG. 9 (e.g., in some cases, no direct interconnection may be provided between a sensor module 308 and the visual indication system 302).

In some embodiments, the control module 304 can be configured to receive signals from other electrical devices, which may allow feedback-based or other control of various devices or the power machine 300 in general. For example, the power machine 300 may include a sensor module 308 including one or more sensors that are configured to detect indicators of one or more operating conditions for the power machine 300 and electrically communicate the detected indicators to the control module 304 (e.g., temperature sensors, pressure sensors, current or voltage sensors, switches to detect levels or otherwise indicate operational states, rotational or other speed sensors, light or moisture sensors, etc.). Correspondingly, the control module 304 can be configured to execute particular operations in response to the detected operating conditions. For example, in the illustrated embodiment, the control module 304 can be configured to operate the visual indication system 302 according to one or more detected operating conditions.

As used herein, detection of an operating condition can include direct detection of an operating condition (e.g., temperature, pressure, engine speed, travel speed, lift arm height or other work element condition, etc.) or can include detection of one or more indicators that represent or can be used to derive an operating condition (e.g., speed of an intermediary component as may be used to derive travel speed, pressure in a hydraulic line as may be used to derive an operational state of an implement or other work element, current in a motor as may be used to derive torque applied to a work element, a status of a wireless communications channel or module as may be used to derive a current control status or mode, etc.). Similarly, communication of an operating condition can include communication of a value that directly represents the operating condition (e.g., a speed, pressure, or temperature value) or communication of a value that can be used to derive the operating condition. Correspondingly, therefore, detecting an indicator and communicating the indicator may in some cases include detecting a particular value and transmitting data that is derived from, but is not necessarily identically equal to, the detected value.

As will be discussed further below, the visual indication system 302 may be any system that is configured to provide visual indication to an operator or to observers within or near the power machine 300 (i.e., observers within line of sight to the power machine 300 or a working area of the power machine 300). For example, a visual indication system may be an electronic illumination device that is provided in the form of one or more known types of light elements including one or more light-emitting diodes (“LEDs”) or other light sources, such as, e.g., incandescent light bulbs, halogen light bulbs, fluorescent light bulbs, or any combination of incandescent, fluorescent, and LED bulbs. In some configurations, a visual indication system may include one or more light sub-assemblies including a housing made of a translucent material, such as, e.g., acrylic or polycarbonate, that is configured to at least partially receive, cover, or surround one or more light sources and transmit light from the one or more light sources. In some embodiments, light sub-assemblies can be fixed sub-assemblies. In other words, some light sub-assemblies can be fixedly secured to (or by) a mounting structure so as not to be movable relative to a supporting frame of a power machine during operation. For example, light sub-assemblies can be integrated into a cab structure of a power machine, below a top panel of a structural envelope (e.g., partial or full enclosure) around the operator station. In some embodiments, fixed light sub-assemblies can be fixed-direction light sub-assemblies, without internal mechanisms to change the direction in which light is projected.

Visual indication systems according to some embodiments can be configured to selectively provide visual indicators of a variety of types, including as can be used to indicate different types of operating conditions. In this regard, for example, some embodiments can generally be configured to provide multiple visual indications that are differentiated from each other by variations of particular parameters, such as, e.g., color, brightness (i.e., luminous intensity), patterns (i.e., regular or irregular spatial patterns or sequences of changes in illumination, intensity, color, or location), etc. Correspondingly, visual indication systems according to some embodiments are generally configured to controllably provide illumination having any one or more of a plurality of colors, a plurality of brightness, or a plurality of patterns, or to controllably provide illumination having a plurality of one or more select colors, one or more select intensities, or one or more select patterns. For example, in some embodiments, a visual indication system may be configured to selectively emit light of at least two colors. That is, the visual indication system may be configured to selectively switch between two colors (and, in some cases, provide illumination in both colors simultaneously). As another example, in some embodiments, a visual indication system may be configured to selectively emit light of at least two intensities. Further, in some embodiments, a visual indication system may be configured to emit light with at least two patterns. In some cases, different light patterns may include different structured light patterns (e.g., grids, controlled distribution of colors within a lighted area, etc.). In some cases, different light patterns may include the projection of light, on average, in different directions. Accordingly, for example, the direction of the projected light may itself provide information regarding an operational state for the power machine, as well as or instead of other patterns of the light, such as color, structure light patterns, etc.

Generally, visual indication systems according to this disclosure can be configured to primarily project illumination for observation from outside of an operator station (if any) of a power machine relative to which the visual indication system is operating. For example, light sub-assemblies of some embodiments can be arranged external to an operator station or to a power machine generally (i.e., exposed to directly illuminate surroundings of the operator station or power machine), or can be otherwise configured to primarily illuminate external areas. In some embodiments, as also noted above, light sub-assemblies can be configured to primarily illuminate select external areas (e.g., primarily forward of an operator station, or primarily forward and laterally relative to an operator station).

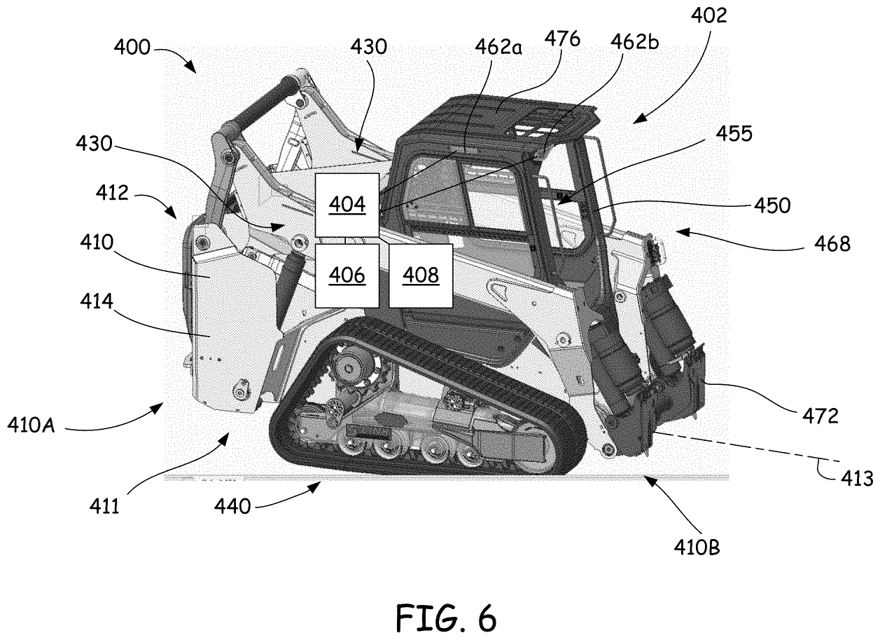

FIG. 6 illustrates an example arrangement of components for a power machine 400 that is one particular example of the power machine 100 illustrated in FIG. 1 and discussed above, and that includes a visual indication system 402 that is one particular example of the visual indication system 302 illustrated in FIG. 5 and discussed above. The power machine 400 is similar in some ways to the loader 200 described above and like numbers represent similar parts unless otherwise indicated below. For example, like the loader 200, the power machine 400 includes a frame 410, a lift arm structure 430, and a traction system 440, each of which are substantially similar in design and functionality to the components of the loader 200. Further, the power machine 400 is similar to the exemplary power machine 300 illustrated broadly in FIG. 5. For example, the power machine 400 includes the visual indication system 402, a control module 404, a power system 406, and a sensor module 408. (As generally noted above, although the control module 404, the power system 406, and the sensor module 408 are illustrated separately from the visual indication system 402, some embodiments of a visual indication system can include one or more of these types of components.)

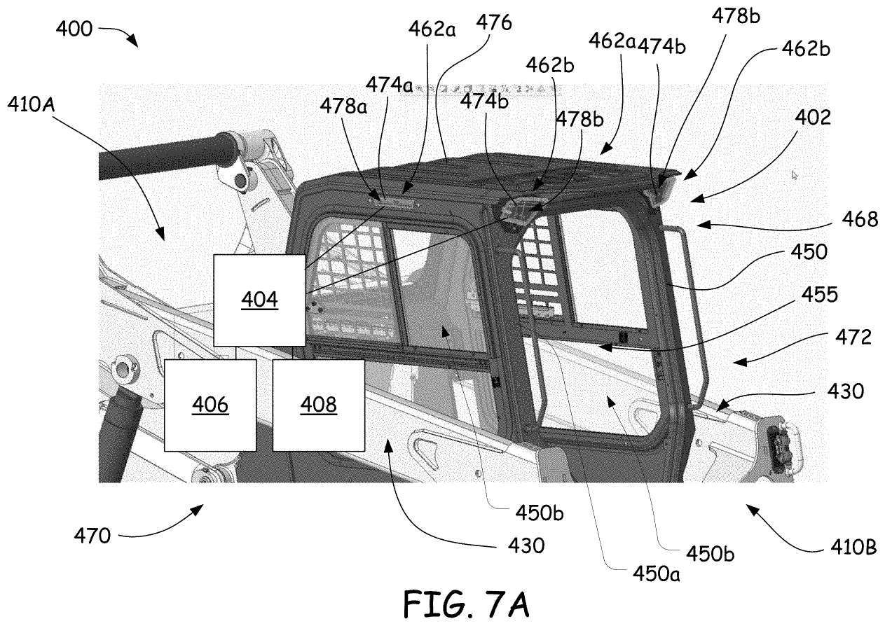

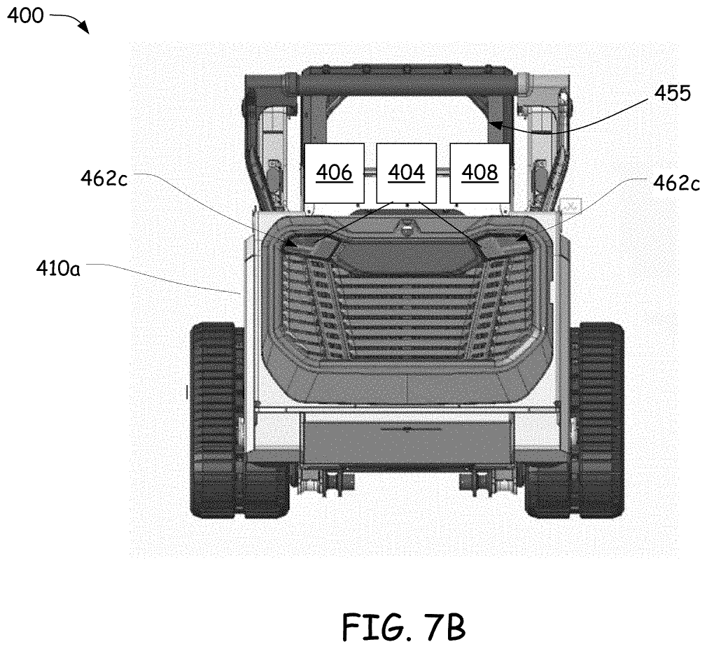

As shown in FIGS. 6 and 7A, the frame 410 is substantially similar to the frame 210 of the power machine 200, although the specific elements of the frame 410 discussed herein are provided for illustrative purposes and are not intended to represent the only type of frame for a power machine on which the embodiments of this disclosure can be used. Generally, the frame 410 includes a rear frame end 410A and a front frame end 410B, and further includes a lower frame portion 411 and an upper main frame 412. Further, the frame is substantially symmetrical about a longitudinal axis 413 that is centered between upright lateral walls 414, although a variety of other structural configurations are possible, including frames that are not substantially symmetrical.

Referring to FIG. 6, in particular, the frame 410 is configured to support a cab 450 similar to cab 252 of power machine 200, and can correspondingly include an operator station 455 from which an operator can manipulate various control devices (i.e., an operator control system) to cause the power machine to perform various work functions. Similar to the operation station 255 of power machine 200, the operator station 455 can include an operator seat (not shown) and various operation input devices (not shown), including control levers that an operator can manipulate to control various machine functions. As shown in FIG. 7A, rigid frame structure 450a of the cab, as supported on the main frame 410 (see FIG. 6), defines view areas 450b (e.g., windows and a door, as shown) through which an operator within the operator station 455 can observe the surroundings and operations of the power machine 400. In other embodiments, an operator station may be located differently on a main frame (e.g. at a rear end thereof), may include differently bounded view areas, or may sometimes not be formed as part of an enclosed cab (e.g., may be formed with an open-topped standing platform or as an operator-interface area for a walk-behind machine or a seated operator station on a vehicle without a cab). Further, some embodiments may not include an integrate operator station of any kind.

The frame 410 is also configured to support a variety of other components. For example, similar to the frame 210 of power machine 200, the frame 410 supports the power system 406 which is configured to provide power for executing functions on the power machine 400, including operations using the traction system 440 and the lift arm structure 430. In the illustrated embodiment, the power system 406 includes one or more power sources (not shown) that are capable of generating or storing power for use on various machine functions. On power machine 400, the power system 406 includes rechargeable batteries (not shown). Other power machines can include electric generators, internal combustion engines, or various other known power sources. The power system 406 can also include a power conversion system, which is operably coupled to the power source. Power conversion system can be, in turn, coupled to one or more components, e.g., the lift arm structures 430, which can perform a function on the power machine. Power conversion systems in various power machines can include various components, including mechanical transmissions, hydraulic systems, and the like.

In some embodiments, other power sources may be used, including other electrical storage devices (e.g., devices including capacitors). In some embodiments, combinations of power sources of different types, known generally as hybrid power sources, may be used. For example, although the power machine 400 is illustrated as including an internal combustion engine, some embodiments can include such an engine in combination with an electrical power system, with the engine being configured to charge a battery assembly or other electrical storage device for electrically powered operations.

Further, similar to the power machine 300 of FIG. 5, the power machine 400 includes the control module 404 that is coupled to the power system 406. The control module 404 can thus be configured to control the routing of power from the power system 406 to other devices of the power machine 400, including routing of electrical power to the visual indication system 402, as further discussed below. Further, in some embodiments, the control module 404 can be configured to receive signals from other devices to facilitate feedback-based or other control of specific components of the power machine 400, or of the power machine 400 in general. For example, in some implementations, the control module 404 can be configured to receive signals from the sensor module 408 and to provide control signals to other components accordingly. Further in some embodiments, the control module 404 can selectively control certain components in response to operator inputs from within the operator station 455, or as part of a predetermined (e.g., automated) control strategy based on one or more locally or remotely stored control algorithms, including in response to signals from the sensor module 408. In some embodiments, as further discussed below, the control module 404 can operate the visual indication system 402 in different ways depending on detected operating conditions (e.g., the particular types of operations currently being performed, environmental conditions, etc.).

In different embodiments, components of a power source can be located and supported relative to a frame in different ways. For example, in the illustrated embodiment, the power system 406 and the control module 404 is disposed rearward of the cab 450. However, other configurations are possible.

Still referring to FIGS. 6 through 7B, the visual indication system 402 in the present embodiment includes a plurality of light sub-assemblies 462a, 462b, 462c provided on the power machine 400 (e.g., above or otherwise aligned relative to head lights 464b, as shown in FIG. 9). Particularly, the light sub-assemblies 462a, 462b are disposed on the cab 450 of the power machine 400 and the light sub-assemblies 462c are disposed on a tailgate at the rear of the power machine 400 (e.g., above or otherwise aligned relative to rear lights 464c configured to separately illuminate behind the power machine 400, as shown in FIG. 9). However, other configurations are possible, including configurations in which a different number or orientation of light sub-assemblies are provided on any given side of a power machine, and configurations in which light sub-assemblies are provided at locations other than on a cab or tailgate.

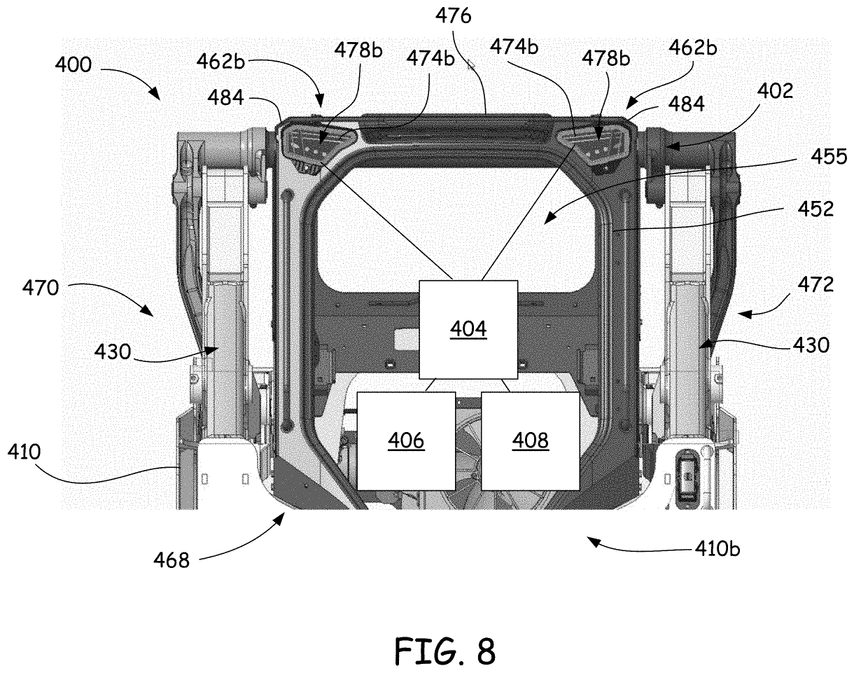

Generally, it may be useful for light sub-assemblies of a visual indication system to be equipped to project illumination in different directions (e.g., uniformly, or selectively). Correspondingly, the visual indication system 402 includes two lateral light sub-assemblies 462a disposed on opposing sides of the cab 450 (only one shown in FIG. 6), and two front light sub-assemblies 462b provided on a front side 468 of the cab 450 (see also FIG. 8), as well as the rear light sub-assemblies 462c. Each of the light sub-assemblies 462a, 462b, 462c is electronically-controlled and configured to emit light from a light source. As such, the sub-assemblies 462a, 462b, 462c can collectively project illumination to all sides of the power machine 400, simultaneously or selectively. Relatedly, in some embodiments, it may be useful to orient light sub-assemblies of a visual indication system so as to project illumination to indicate operating conditions for the power machine without interfering with visibility through view areas of an operator station. Correspondingly, for example, some or all of the light sub-assemblies of a visual indication system can sometimes be integrated into a cab structure to be—or to project light from—above a view area of the cab structure (e.g., as shown for the light sub-assemblies 462a, 462b relative to the view areas 450b in FIG. 7A).

Referring again to FIG. 7A, in particular, one of the lateral light sub-assemblies 462a is shown in detail, proximate a right side 470 of the frame 410. In the illustrated embodiment, the opposing lateral light sub-assembly 462a (hidden from view) is provided proximate a left side 472 of the frame 410 and is substantially identical in design and functionality to the lateral light sub-assembly 462a illustrated in FIG. 7. Accordingly, description and illustration of the lateral light sub-assembly 462a is generally applicable to both of the lateral light sub-assemblies 462a. However, in some embodiments, different types of light sub-assemblies can be used at different locations, or a single light sub-assembly may be configured to project light to multiple sides of a power machine. Further, although the illustrated structural arrangements of the various light sub-assemblies 462a, 462b, 462c can be useful in some cases, a variety of known sub-assemblies to selectively provide different types of light are generally possible.

Continuing, the lateral light sub-assembly 462a includes a light housing 474a that is substantially elongate and disposed on the cab 450 so that it extends substantially in a direction defined by the central axis 413 (see, e.g., FIG. 6). For example, the light housing 474a extends substantially along a roof 476 of the cab 450. The light housing 474a can be made of a translucent material, such as, e.g., acrylic or polycarbonate, that is configured to at least partially receive, cover, or surround a light source 478a. In the illustrated embodiment, the light source 478a is provided in the form of one or more bulbs including one or more LEDs, but other configurations are possible. More specifically, the light source 478a can be an LED strip that is sized to be received by the elongate light housing 474a, the LED strip having a plurality of LEDs disposed along a linear path. In the illustrated example, the light sub-assembly 462a is a fixed and fixed-direction light sub-assembly configured to primarily illuminate an area laterally to the side of the power machine 400, although other configurations are possible. Similarly, the light sub-assembly 462a is located below (and protected by) the top panel of the cab structure that forms the roof 476 and above the adjacent view areas 450b, although other configurations are possible.

Turning to FIG. 8, the front light sub-assemblies 462b are configured similarly to the lateral light sub-assemblies 462a. Generally, the front light sub-assemblies 462b are substantially identical in design and functionality to each other but exhibit symmetric constructions relative to each other. One of the front light sub-assemblies 462b is disposed on the front side 468 of the cab 450 proximate the left side 472 of the frame 410, whereas the other of the front light sub-assemblies 462b is disposed on the front side 468 of the cab 450 proximate the right side 470 of the frame 410. Each of the front light sub-assemblies 462b includes a light housing 474b that may be shaped to substantially correspond to a corner 484 of the cab 450 proximate the roof 476. The specific shape of the light housings in any given configuration may reflect the surrounding cab structure more than any other consideration. Further, similarly to the light housing 474a, each of the light housings 474b can be made of a translucent or transparent material, such as, e.g., acrylic or polycarbonate, that is configured to at least partially receive, cover, or surround a light source 478b. Like the light sources 478a (see, e.g., FIG. 7), the light sources 478b are provided in the form of one or more bulbs including one or more LEDs, but other configurations are possible. More specifically, the light source 478b includes a plurality of bulbs having one or more LEDs that extend substantially linearly within the respective light housing 474b. Similar to the light sub-assemblies 462a, the light sub-assemblies 462b are a fixed and fixed-direction light sub-assemblies in the illustrated embodiment, configured to primarily illuminate an area in front of the power machine 400, although other configurations are possible. The light sub-assemblies 462b are also located below (and protected by) the top panel of the cab structure that forms the roof 476 and above the adjacent view area 450b, although other configurations are possible.

In the illustrated example, the light sub-assemblies 462c also are fixed and fixed-direction light sub-assemblies, which are in particular configured to primarily illuminate an area behind the power machine 400. However, other configurations are possible. For example, some visual indication systems may not include rear light sub-assemblies or may otherwise be configured not to project light primarily to the rear (e.g., to project light primarily in a region spanning 270 degrees, centered on the forward direction).

Although the visual indication system 402 according to the present embodiment includes a plurality of discrete LED light sub-assemblies, power machines according to other embodiments may use different visual indication systems, such as one or more LED light strips, a plurality of individually housed LED lights, or a single LED. Further, visual indicators according to additional embodiments may include incandescent light bulbs, halogen light bulbs, fluorescent light bulbs, or any combination of incandescent, fluorescent, and LED light sources. It is also contemplated that light housings according to embodiments of the disclosure could include a luminescent structure or material, such as a tape, paint, or other artificially luminescent article.

Referring again to FIG. 7, while the power machine 400 according to the present embodiment includes a total of six light sub-assemblies 462a, 462b, 462c, power machines according to embodiments of the present disclosure may incorporate visual indication systems having more or fewer light sub-assemblies. Further, while the light sub-assemblies 462a, 462b according to the illustrated embodiment are disposed on the cab 450 proximate the roof 476 (e.g., below and protected by a top panel of the roof 476, as shown), power machines according to embodiments of the present disclosure may include light sub-assemblies disposed at different locations on the cab or on the power machine in general. For example, one or more light sub-assemblies may be provided directly on a frame of a power machine. In some embodiments, one or more light sub-assemblies can be arranged proximate a lower region of a frame (e.g., below a roof of a cab). In some embodiments, light assemblies can be integrated into a main frame of a power machine or a frame of an operator station (e.g., directly attached to a frame at predetermined locations). Thus, for example, it may be possible to convey visual indications to observers without requiring relatively large protruding light assemblies on top of a cab (or elsewhere). Further, in some embodiments, one or more light sub-assemblies may be positioned proximate a front frame end or a rear frame end of a frame, although some embodiments may include light sub-assemblies that are distinct from headlights, brake lights, rear work lights, or other standard illumination assemblies (e.g., turn signals or reverse-travel lights) that may also be disposed on a front or rear end of a power machine. Additionally or alternatively, in some embodiments, at least a portion of a visual indication system can be disposed within or above a cab of a power machine.

FIG. 9 illustrates a schematic representation of the power machine 400 of FIGS. 6-8. Particularly, the power machine 400 is illustrated with the visual indication system 402, the control module 404, the power system 406, and the sensor module 408 electrically interconnected with each other and with the light sub-assemblies 462a, 462b, 462c. More specifically, the control module 404 can be configured to communicate with the sensor module 408 so that the control module 404 can individually or collectively control operation of the light sub-assemblies 462a, 462b, 462c to project illumination in ways that correspond to—and provide visual indication of— the detected operating conditions. In general, any known type of communication architecture for transmission of signals between these components can be used, including known wired and wireless architectures.

The sensor module 408 can generally include one or more sensors of any of a variety of known types for detecting various operating conditions for the power machine. For example, one or more sensors may be configured to detect indicators of one or more internal operating conditions, such as, e.g., internal component pressure or temperature, electrical connection statuses, lift arm height, internal temperatures, load weight, load or power at particular motors or actuators, power machine travel speed, engine (or other power source) speed, battery condition (e.g., charge), etc. Additionally or alternatively, one or more sensors may be configured to detect indicators of one or more external operating conditions, such as, e.g., location or proximity of potential obstructions, other power machines, or areas of interest, environmental conditions including temperature, wind, and wetness (e.g., ground wetness or precipitation), a power machine's location (e.g., using GPS), direction of machine travel, or general orientation, terrain geometry (e.g., a slope or elevation of a travel surface), etc. The detected indicators can then be communicated to the control module 404 to inform execution of various control strategies.

Still referring to FIG. 9, in response to one or more operating conditions detected by the sensor module 408, the control module 404 can control components of the power machine 400, including, but not limited to, the visual indication system 402. More specifically, depending on the operating conditions, the visual indication system 402 may be at least partially illuminated to establish an illumination region 490 substantially surrounding the power machine 400. In some implementations, an illumination region may surround an entirety of a power machine, e.g., 360 degrees around the machine, as shown in FIG. 9. In some implementations, however, an illumination region may be around only a portion of a power machine e.g., less than 360 degrees. For example, in some embodiments, an illumination region may predominately surround a front frame end of a power machine (e.g., when an illumination system or visual indication is configured to illuminate primarily in forward and lateral directions). In some embodiments, an illumination region may predominately surround a rear frame end of a power machine (e.g., when an illumination system or visual indication is configured to illuminate primarily in rearward and lateral directions).

In some embodiments, as indicated with short-dashed lines in FIG. 9, select lighting sub-assemblies can be configured to project illumination over only a partial area of a total potential illumination region (e.g., the region 490). Accordingly, for example, select lighting sub-assemblies can be activated to illuminate various parts of a total potential illumination region and indications of operating conditions can be provided by total illumination from a visual indication system, by illumination from only one or more lighting sub-assemblies of a visual indication system, or by the combined effects of illumination of a select subset of lighting sub-assemblies of a visual indication system (e.g., via overlapping projection regions, sequential or other patterned operation, or otherwise). Although the illumination region 490 is shown as a rectangle in FIG. 9, in actuality the illumination region can extend beyond the rectangle along some or all of the perimeter of the rectangle, or can otherwise be differently shaped. Further, although FIG. 9 illustrates, in particular, a projected area of an illumination region onto the ground surrounding the power machine 400, illumination regions may generally project in three-dimensional space and can thus include areas at various elevations and distances relative to a power machine. Further, as also noted above, certain of the illustrated lighting sub-assemblies (e.g., the sub-assemblies 462c) can be excluded in some cases.

As generally noted above, a visual indication system can be configured to provide a visual indication corresponding a wide variety of different light types. For example, in response to detecting one or more particular operating conditions, the visual indication system 402 may cause one or more of the light sub-assemblies 462a, 462b, 462c to individually or collectively, emit light of one or more corresponding colors, brightnesses, or patterns within part or all the illumination region 490 to visually indicate the one or more operating conditions to an observer. Generally, an illumination region for the disclosed embodiments may extend primarily to the exterior of a power machine (e.g., so as to be readily visible from outside of an operator station of the power machine). In some cases, however, an illumination region may extend into an operator station, in whole or in part.

In some cases, a plurality of visual indications can be predetermined and associated with particular operating conditions (e.g., via a look-up table stored in a memory of a power machine). Thus, for example, upon detection of a particular operating condition, a control module of a power machine can call to a stored association between predetermined visual indications and corresponding operating conditions so as to selectively project appropriate visual indication(s) based on relevant detected operating condition(s). In some embodiments, a user interface can be provided (e.g., a touchscreen (not shown)) by which user input can be received to define particular visual indications or associate particular visual indications with particular operating conditions (e.g., to associate different particular colors of light with different particular parameters exceeding different particular associated threshold values).

In some implementations, devices or systems disclosed herein can be utilized, manufactured, or installed using methods embodying aspects of the disclosure. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the disclosure, of the utilized features and implemented capabilities of such device or system.

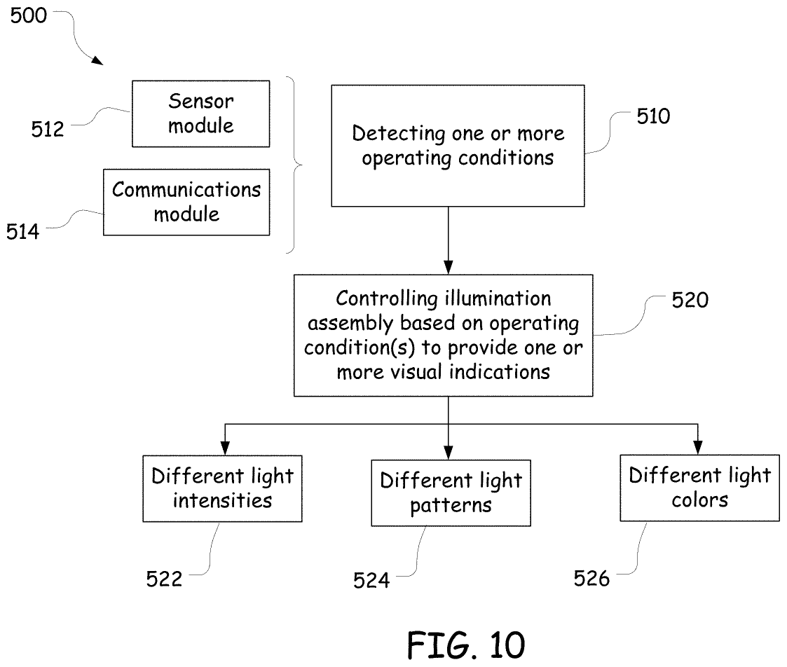

Correspondingly, for example, FIG. 10 illustrates an example method 500 for providing visual indications of operating conditions for a power machine. In particular, the method 500 can include detecting, at block 510, one or more operating conditions, including through the use of a one or more sensors of any variety of known types. In some cases, as further detailed above, one or more sensors can detect indicators of internal operating conditions, including engine or travel speed, internal pressures or temperatures, etc. In some cases, one or more sensors can detect indicators of external operating conditions, including environmental conditions and information regarding surrounding objects or terrain. Thus, as also illustrated by FIG. 10, detecting operating condition(s) at block 510 can include receiving signals from a sensor module 512. Similarly, in some cases, detecting operating condition(s) at block 510 can include receiving signals from a communications module 514 (e.g., a wireless communication module for remote control of the power machine via known wireless communication channels and protocols, or other known modules for electronic communication). For example, detecting an operating condition at block 510 can include detecting a status of the communications module 514 (or a channel enabled by the module 514) as may indicate, for example, that the power machine is or is not connected for (or actively operating under) remote control, that the power machine is or is not connected to receive (or actively receiving) software or firmware updates, etc.

Once indicators of operating conditions have been detected (at block 510), an illumination assembly can be controlled (at block 520) accordingly, to provide one or more corresponding visual indications. For example, based on receiving indicators relative to a particular operating condition, a control device can automatically, electronically control one or more light sub-assemblies to project illumination having a corresponding one or more light intensities 522, light patterns 524, or light colors 526.

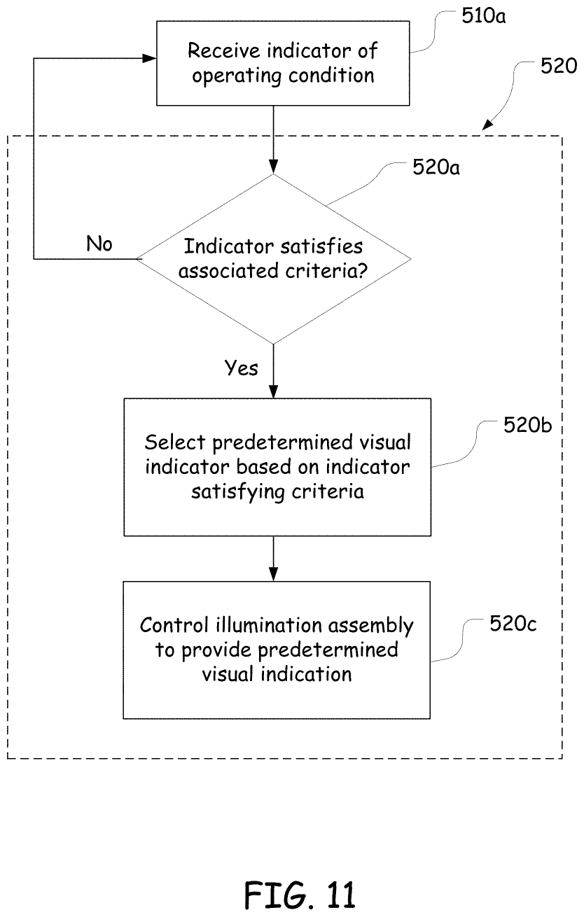

As a more specific example, FIG. 11 illustrates further operations that may be associated with particular implementations of the method 500 of FIG. 11. At block 510a, operations of the method can include receiving an indicator of an operating condition from a sensor or a communications module (see also FIG. 10). As a particular implementation of operations at block 520 (see also FIG. 10), operations at block 520a can include determining whether the received indicator satisfies an associated criteria. For example, operations at block 520a can include determining whether a fuel level, a charge level, a temperature, a pressure, a control mode, an operational state (e.g., powered but not operable, powered and operable relative to limited functionality, powered and fully operable, etc.), a power source power condition (e.g., power level, power rating, projected runtime at current or historical loading, etc.), etc. satisfy corresponding thresholds or other criteria (e.g., type of control mode or operational state) for which a visual indicator is to be provided (e.g., to alert remote observers or operators of relevant information for the power machine).

If the relevant indicator satisfies the relevant criterium at block 520a, the method can include, at block 520b, selecting a visual indicator from a plurality of predetermined visual indicators that corresponds to the relevant operating condition. At block 520b, for example, based on operations at block 520a, a first visual indicator can be selected (e.g., identified from a look-up table) based on detecting an overheat condition, a second visual indicator can be selected based on detecting a low power or low fuel condition, a third visual indicator can be selected based on detecting a powered and operable status for the power machine, a fourth visual indicator can be selected based on detecting remote control operation of the power machine or availability of a remote control mode (e.g., based on availability of an active channel for remote control), etc.

Once a visual indicator has been selected at block 520b, the method can include, at block 520c, controlling an illumination assembly to provide the selected visual indicator. For example, if a predetermined visual indicator for a first detected operating condition includes projecting light with a particular color, pattern, or intensity, primarily in a particular direction, one or more lighting sub-assemblies of a power machine can be controlled accordingly (e.g., using known approaches for control of LED color, intensity, etc.). Therefore (or simultaneously), other visual indicators can be similarly projected primarily exterior to a power machine to indicate other detected operating conditions.

Therefore, power machines according to embodiments of the present disclosure may provide improved communication of information regarding operating conditions, including by incorporating a visual indication system, such as the exemplary visual indication systems discussed herein, to provide to an operator or other observer one or more visual indicators that correspond to one or more detected operating conditions. In this way, for example, observers can be readily informed, even in loud or low-visibility environments, regarding relevant operating states for a power machine, including through the use of particular light colors, levels of brightness, or spatial or temporal patterns.

In some embodiments, aspects of the disclosure, including computerized implementations of methods according to the disclosure, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the disclosure can be implemented as a set of instructions, tangibly embodied on a non-transitory computer-readable media, such that a processor device can implement the instructions based upon reading the instructions from the computer-readable media. Some embodiments of the disclosure can include (or utilize) a control device such as an automation device, a special purpose or general purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.).

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally it should be appreciated that a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the scope or spirit of the claimed subject matter.

Certain operations of methods according to the disclosure, or of systems executing those methods, may be represented schematically in the FIGS. or otherwise discussed herein. Unless otherwise specified or limited, representation in the FIGS. of particular operations in particular spatial order may not necessarily require those operations to be executed in a particular sequence corresponding to the particular spatial order. Correspondingly, certain operations represented in the FIGS., or otherwise disclosed herein, can be executed in different orders than are expressly illustrated or described, as appropriate for particular embodiments of the disclosure. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” “block,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “only one of,” or “exactly one of” For example, a list of “one of A, B, or C” indicates options of: A, but not B and C; B, but not A and C; and C, but not A and B. A list preceded by “one or more” (and variations thereon, e.g., “at least one of”) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

Although the present disclosure has been described by referring to preferred embodiments, workers skilled in the art will recognize that changes may be made in form and detail without departing from the scope of the discussion.

What is claimed is:

1. A power machine, the power machine comprising:
a main frame that supports an operator station;
a traction system coupled to the main frame;
a work element operably coupled to the main frame;
an electronic control module; and
a visual indication system that is configured to emit a plurality of visual indications;
wherein the electronic control module is configured to detect an operating condition for the power machine, select one or more visual indications of the plurality of visual indications based on the detected operating condition for the power machine, and electronically control the visual indication system to emit the selected one or more visual indications externally to the operator station.

2. The power machine of claim 1, wherein the visual indication system includes a plurality of light sub-assemblies, including a first light sub-assembly configured to project illumination to a first side of the main frame, and a second light sub-assembly configured to project illumination to a second side of the main frame.

3. The power machine of claim 2, wherein the plurality of light sub-assemblies further includes a third light sub-assembly configured to project illumination to a third side of the main frame and a fourth light sub-assembly configured to project illumination to a fourth side of the main frame.

4. The power machine of claim 2, wherein the visual indication system is arranged to project illumination primarily forward of and laterally away from the operator station of the power machine.

5. The power machine of claim 4, wherein the first and second light sub-assembly are fixed-direction light sub-assemblies.

6. The power machine of claim 2, wherein the operator station includes a cab structure that defines a structural envelope of the operator station; and
wherein the first and second light sub-assemblies are integrated into the cab structure to project light away from the operator station.

7. The power machine of claim 2, wherein the first light sub-assembly is a front light sub-assembly integrated onto one or more of the main frame or a frame of the operator station and oriented to project visual indications forward of the power machine;
wherein the second light sub-assembly is a right side light sub-assembly integrated onto one or more of the main frame or the frame of the operator station and oriented to project visual indications to the right side of the power machine; and
wherein a third light sub-assembly of the plurality of light sub-assemblies is a left side light sub-assembly integrated onto one or more of the main frame or the frame of the operator station and oriented to project visual indications to the left side of the power machine.

8. The power machine of claim 7, wherein the frame of the operator station defines view areas for an operator of the power machine within the operator station; and
wherein at least one of the first, second, or third light sub-assemblies is integrated onto the frame of the operator station to project the plurality of visual indications from above the view areas defined by the frame of the operator station.

9. The power machine of claim 8, further comprising:
an illumination system including a set of one or more headlights configured to illuminate terrain ahead of the main frame for driving operations, and a set of one or more lights configured to illuminate behind the main frame.

10. The power machine of claim 1, wherein the plurality of visual indications includes a first visual indication that includes projected light having a first light intensity and a second visual indication that includes projected light having a second light intensity different from the first light intensity.

11. The power machine of claim 1, wherein the plurality of visual indications includes a first visual indication that includes projected light having a first pattern and a second visual indication that includes projected light having a second pattern different from the first pattern.

12. The power machine of claim 1, wherein the plurality of visual indications includes a first visual indication that includes projected light having a first color and a second visual indication that includes projected light having a second color different from the first color.

13. The power machine of claim 1, further comprising:
a sensor module configured to detect one or more external environmental conditions;
wherein the electronic control module is configured to detect the operating condition based on detecting the one or more external environmental conditions.

14. The power machine of claim 13, wherein the one or more external environmental conditions include at least one of an environmental temperature or an environmental wetness.

15. The power machine of claim 13, wherein the one or more external environmental conditions include at least one of an elevation or a slope of surrounding terrain.

16. The power machine of claim 13, wherein the one or more external environmental conditions include a presence of an obstruction detected by the sensor module.

17. The power machine of claim 13, further comprising:
a sensor module configured to detect one or more internal operating conditions for the power machine;
wherein the electronic control module is configured to detect the operating condition for the power machine based on the detected one or more internal operating conditions.

18. The power machine of claim 17, wherein the one or more internal operating conditions include at least one of a work element condition or a power machine speed.

19. The power machine of claim 17, wherein the one or more internal operating conditions include at least one of an internal temperature, a battery capacity condition, or an engine power condition.

20. The power machine of claim 1, wherein the operating condition includes a powered and operable operating condition of the power machine.

21. The power machine of claim 1, wherein the operating condition includes a fault condition for one or more of a temperature sensor, a pressure sensor, or a diagnostics module.

22. The power machine of claim 1, wherein the operating condition includes a status of a communication link between the power machine and a remote control system.

23. An illumination assembly for a power machine, the illumination assembly comprising:
a sensor module configured to detect one or more operating conditions for the power machine;
a communications module configured for wireless communication with systems external to the power machine;
one or more light sub-assemblies arranged exterior to an operator station of the power machine and configured to collectively emit a plurality of different visual indications; and
an electronic control module configured to:
detect at least one operating condition for the power machine based on one or more of: receiving signals from the sensor module corresponding to sensor detection of the at least one operating condition, or determining a state of the communications module; and
in response to detecting the at least one operating condition, control the one or more light sub-assemblies to emit a select one or more visual indications of the plurality of different visual indications to externally indicate the at least one operating condition for the power machine.

24. The illumination assembly of claim 23, wherein a first light sub-assembly of the one or more light sub-assemblies is positioned on a front side of the power machine, and a second light sub-assembly of the one or more light sub-assemblies is positioned on a first lateral side of the power machine.

25. The illumination assembly of claim 24, wherein the first and second light sub-assemblies are fixed-direction light sub-assemblies integrated into a cab structure of the power machine.

26. The illumination assembly of claim 23, wherein the electronic control module is configured to control the one or more light sub-assemblies to selectively indicate two or more of: a presence of an external object relative to the power machine; a powered and operable state of the power machine; or a control-communication status for the power machine.

27. A method of indicating a plurality of operating conditions of a power machine, the method comprising:
receiving, with an electronic control module, signals from one or more of a sensor module or a communications module configured for wireless communication with systems external to the power machine, the signals corresponding to one or more operating conditions included in the plurality of operating conditions for the power machine; and
in response to receiving the signals:
selecting, with the electronic control module, one or more visual indications of a plurality of visual indications that one or more light sub-assemblies of an illumination assembly of the power machine are configured to emit, the one or more visual indications corresponding to at least one of the one or more operating conditions; and
controlling the illumination assembly, with the electronic control module, to cause one or more light sub-assemblies of the illumination assembly to emit the selected one or more visual indications to indicate the at least one operating condition by illuminating exterior surroundings of the power machine.

28. The method of claim 27, wherein the plurality of visual indications include visual indications of one or more of different light intensities, different patterns, or different light colors.

29. A power machine, the power machine comprising:
a main frame that supports an operator station;
a traction system coupled to the main frame;
a work element operably coupled to the main frame; and
a visual indication system that is configured to emit a plurality of visual indications to indicate one or more operating conditions for the power machine, the visual indication system including one or more light sub-assemblies that are integrated onto one or more of the main frame or a frame of the operator station.

30. A power machine, the power machine comprising:
a main frame that supports an operator station;
a traction system coupled to the main frame;
a work element operably coupled to the main frame; and
a visual indication system that is configured to emit a visual indication to indicate an operating condition for the power machine, the visual indication system including one or more light sub-assemblies that are integrated onto one or more of the main frame or a frame of the operator station.
